(19) United States
(12) Patent Application Publication
(10) Pub. No.: US 2011/0129202 A1
(43) Pub. Date: Jun. 2, 2011

(54) SYSTEM AND METHOD FOR DETERMINING BIT STREAM COMPATIBILITY

(75) Inventor: Kourosh Soroushian, San Diego, CA (US)

(73) Assignee: DivX, LLC, San Diego, CA (US)

(21) Appl. No.: 12/957,224

(22) Filed: Nov. 30, 2010

Related U.S. Application Data
(60) Provisional application No. 61/265,363, filed on Dec. 1, 2009.

(51) Int. Cl. H04N 5/917

(52) U.S. Cl. 386/355; 386/E05.003

(57) ABSTRACT

Systems and methods for determining whether a decoder can playback compressed video identified as being encoded with an operating profile and/or level unsupported by the decoder are shown. Systems and methods are described for playing back video encoded as an elementary bitstream, where the elementary bitstream has a specified encoding profile and satisfies at least one playback condition. A number of embodiments include a decoder that is incapable of playing back video encoded in accordance with the specified encoding profile. In addition, the decoder is configured to locate the specified encoding profile within the elementary bitstream. The decoder is also configured to determine whether the elementary bitstream satisfies the at least one playback condition in response to the location of the specified encoding profile within the elementary bitstream. Furthermore, the decoder is configured to commence playback of the elementary bitstream based upon the determination that the at least one playback condition is satisfied.

### CROSS-REFERENCE TO RELATED APPLICATIONS

The current application claims priority to U.S. Provisional Application No. 61/265,363 filed Dec. 1, 2009, the disclosure of which is incorporated herein by reference.

### FIELD OF THE INVENTION

The present invention generally relates to playback of media files and more specifically to systems and methods for determining bit stream compatibility.

### BACKGROUND OF THE INVENTION

Various techniques can be utilized to compress video during encoding. Standards for video compression, such as the AVC/H.264 video compression standard developed by the ITU-T Video Coding Experts Group together with the ISO/IEC Moving Picture Experts Group (MPEG), encourage the encoding of a wide array of video content in accordance with the standard so that the encoded video can be played back using a single decoder based on the standard. The availability of a large amount of content in a particular standard format can drive the inclusion of decoders capable of playing back video encoded in accordance with the standard in many different categories of device. The inclusion of video playback capabilities to various device categories has led to the popularity of viewing multimedia files on devices such as cell phones, hand-held computers and media players, as well as traditional consumer electronic devices such as BluRay and DVD players.

Different categories of device typically possess different capabilities with respect to the decoding of video and audio streams and the playback of the video and audio streams. For example, a cell phone screen typically has significantly fewer pixels than a high definition television. Therefore, many standards based multimedia encoding formats establish operating profiles that ensure playability of multimedia files across specific device categories. Each operating profile is typically a set of operating parameters within a standard designed to accommodate the typical playback capabilities of a category of devices (e.g. mobile phone or home theater). In addition to standards bodies, industry groups consisting of one or more participants may also recommend and/or mandate operating profiles which help to further target the standard operating points to particular use cases or device categories. These operating points may be a subset or a superset of the profiles defined by the underlying standard. When content is encoded in accordance with a particular standard or industry mandate and/or recommendation, an operating profile compatible with the categories of device on which the content is intended to be viewed can be selected and the set of operating parameters associated with the profile used in the encoding of the content. In many instances, the container file format used to contain the compressed video includes a data field that identifies the operating profile used in the encoding of the compressed video contained within the container. Alternatively, the operating profile may be signaled by the compressed video headers. In both such cases, the operating profile information can be used by devices to determine whether they are capable of playing back the compressed video within the file.

Content may also be encoded in accordance to profiles which have been defined independently of the profiles defined by a video compression standard. In this case, the standard indicators in the container file or the compressed video headers alone may not be enough to determine compatibility with such custom profiles. As a result, additional means of inspecting the content are utilized in determining profile compatibility.

The H.264 video compression standard specifies both profiles and levels. The profiles define sets of bit stream features for a specific H.264 bit stream, and the levels define restrictions on various features of the H.264 bit stream including the video resolution, the bit-rate, and the frame rate. The standard observes that it may be neither practical nor economic to implement a decoder capable of dealing with all hypothetical uses of the encoding supported within a particular profile. Therefore, the levels specify a set of constraints imposed on values of the syntax elements in the bit stream. These constraints may be simple limits on values. For example, Level 4.0 specifies a maximum HRD rate of 25 Mbit/s in High profile along with a maximum CPB buffer size of 31.25 Mbits for the Video Coding Layer (VCL) data, which makes it more suitable for content distributed via the Internet, and H.264 Level 4.1, specifies a maximum VCL-HRD bit rate of 62.5 Mbits/s in High profile along with a maximum VCL-CPB buffer size of 78.25 Mbits, which makes it more suitable for the creation and distribution of content via optical and disk-based storage. To further tailor these constraints for content distribution via the Internet and decoding with cost-effective devices, a custom profile may specify all the features of the H.264 Level 4.0, along with a maximum VCL-HRD rate of 20 Mbit/s and a maximum VCL-CPB buffer size of 25 Mbits. While the standard H.264 profiles may also impose a 20% increase in both the HRD rate and CPB size when dealing with both VCL and non-VCL data, the custom profile may impose no such increase. Constraints imposed in a particular level may also take the form of constraints on arithmetic combinations of values (e.g. picture width multiplied by picture height multiplied by number of pictures decoded per second).

Devices configured to receive content encoded in accordance with a particular profile and level that has been specified by an encoding standard or an industry recommendation and/or mandate, may refuse to play back content encoded in accordance with a higher profile and/or level. A device can inspect the elementary stream by retrieving a sequence parameter set RBSP (raw byte sequence payload), and determining the profile and level of the H.264 bit stream by inspecting the profile_idc and the level_idc specified in the sequence parameter set RBSP. In the event that the video is encoded in accordance with a supported profile and level, then the device can proceed with playback of the encoded video. Otherwise, the device can refuse to playback the encoded video. For devices that have been built according to customized profile(s), in addition to the profile_idc and the level_idc, other parameters in the file container and the video stream headers may have to be inspected in order to determine compatibility of the content with a particular custom profile.

### SUMMARY OF THE INVENTION

Embodiments of the invention enable playback of certain video streams, which have been labeled as encoded in accordance with a specific operating profile and/or level that is unsupported by a playback device. By analyzing the video stream for characteristics indicative of the stream being compatible with the playback capabilities of a playback device, video streams are identified that can be played back despite being encoded in an unsupported profile and/or level.

Systems and methods are described for playing back video encoded as an elementary bitstream, where the elementary bitstream has a specified encoding profile and satisfies at least one playback condition. A number of embodiments include a decoder that is incapable of playing back video encoded in accordance with the specified encoding profile. In addition, the decoder is configured to locate the specified encoding profile within the elementary bitstream. The decoder is also configured to determine whether the elementary bitstream satisfies the at least one playback condition in response to the location of the specified encoding profile within the elementary bitstream. Furthermore, the decoder is configured to commence playback of the elementary bitstream based upon the determination that the at least one playback condition is satisfied.

In a further embodiment, the specified encoding profile includes at least a bit stream profile.

In another embodiment, the specified encoding profile further includes a bit stream level.

In an additional embodiment, the specified encoding profile includes a bitstream profile and a bitstream level in the sequence parameter set in a raw byte sequence payload within an H.264 bitstream.

In an further embodiment again, the specified encoding profile includes at least one identifier specifying an encoder, a value specifying a rate-control mode, and a value specifying a maximum value for a quantizer parameter.

In another embodiment again, the at least one identifier is a Universally Unique Identifier (UUID).

In an additional embodiment again, the at least one identifier also includes user data.

In a still further embodiment, the at least one playback condition is satisfied where the UUID is 16 bytes, the user data starts with x264 and the rate-control mode is 2pass and the maximum value for a quantizer parameter is 51.

In a still other embodiment, the at least one playback condition is satisfied where the UUID is 16 bytes, the user data starts with x264 and the rate-control mode is adjustable bit rate and the maximum value for a quantizer parameter is 51.

In a still additional embodiment, the at least one playback condition is satisfied where the UUID is 16 bytes, the UUID is 0xdc, 0x45, 0xe9, 0xbd, 0xe6, 0xd9, 0x48, 0xb7, 0x96, 0x2c, 0xd8, 0x20, 0xd9, 0x23, 0xee, 0xef and the rate-control mode is 2pass and the maximum value for a quantizer parameter is 51.

In a yet further embodiment, the at least one playback condition is satisfied where the UUID is 16 bytes, the UUID is 0xdc, 0x45, 0xe9, 0xbd, 0xe6, 0xd9, 0x48, 0xb7, 0x96, 0x2c, 0xd8, 0x20, 0xd9, 0x23, 0xee, 0xef and the rate-control mode is adjustable bit rate and the maximum value for a quantizer parameter is 51.

In a yet other embodiment, the at least one identifier is a User Data Unregistered SEI message.

In a yet additional embodiment, the at least one identifier also includes user data.

In a still another further embodiment, the at least one playback condition is satisfied where the User Data Unregistered SEI message is 16 bytes, the user data starts with x264 and the rate-control mode is 2pass and the maximum value for a quantizer parameter is 51.

In a still another additional embodiment, the at least one playback condition is satisfied where the User Data Unregistered SEI message is 16 bytes, the user data starts with x264 and the rate-control mode is adjustable bit rate and the maximum value for a quantizer parameter is 51.

In a still yet another additional embodiment, the at least one identifier also includes a Universally Unique Identifier (UUID).

In a yet another further embodiment, the at least one playback condition is satisfied where the User Data Unregistered SEI message is 16 bytes, the UUID is 0xdc, 0x45, 0xe9, 0xbd, 0xe6, 0xd9, 0x48, 0xb7, 0x96, 0x2c, 0xd8, 0x20, 0xd9, 0x23, 0xee, 0xef and the rate-control mode is 2pass and the maximum value for a quantizer parameter is 51.

In a yet another other embodiment, the at least one playback condition is satisfied where the User Data Unregistered SEI message is 16 bytes, the UUID is 0xdc, 0x45, 0xe9, 0xbd, 0xe6, 0xd9, 0x48, 0xb7, 0x96, 0x2c, 0xd8, 0x20, 0xd9, 0x23, 0xee, 0xef and the rate-control mode is adjustable bit rate and the maximum value for a quantizer parameter is 51.

In a yet another additional embodiment, the at least one playback condition is a characteristic of the elementary bitstream that is indicative of the ability of the decoder to play back the bit stream.

In a further embodiment, the data to evaluate the playback condition is in user data.

In another embodiment, the user data is in the User Data Unregistered SEI message in the first 1024 bytes of the bitstream.

In an additional embodiment, the user data is in a message concerning the bitstream.

In another further embodiment, the at least one playback condition is an average bit rate.

In another embodiment, the at least one playback condition is satisfied where the average bit rate is less than or equal to 10,000.

In an additional embodiment, the at least one playback condition is satisfied where the average bit rate is less than or equal to 20,000, Hypothetical Reference Decoder (HRD) maximum bit rate is less than or equal to 20,000, and Coded Picture Buffer (CPB) maximum buffer size is less than or equal to 25,000.

A number of embodiments include a method of playing back video encoded as an elementary bitstream using a decoder, where the decoder is incapable of playing back video encoded in accordance with at least one encoding profile. The method includes parsing the elementary bit stream to locate a specified encoding profile. The method furthermore includes evaluating whether the decoder is capable of playing back video encoded in accordance with the specified encoding profile. The method also includes parsing the elementary bit stream to evaluate at least one playback condition when the decoder is incapable of playing back video encoded with the stated encoding profile. The method additionally includes commencing playback of the elementary bitstream when the elementary bit stream satisfies the at least one playback condition.

### BRIEF DESCRIPTION OF THE DRAWINGS

FIG. 1 is a block diagram of a system for distributing video files to decode devices in accordance with an embodiment of the invention.

FIG. 2 is a flow chart illustrating a process for playing back video in accordance with an embodiment of the invention.

FIG. 3 is a flowchart illustrating a process for playback of an H.264 elementary stream in accordance with an embodiment of the invention.

FIG. 4 is a flowchart illustrating a process for determining whether an elementary stream meets predetermined playback conditions for playback by a decoder built according to a customized profile in accordance with an embodiment of the invention.

### DETAILED DISCLOSURE OF THE INVENTION

Turning now to the drawings, systems and methods for determining whether a decoder can playback compressed video identified as being encoded with an operating profile and/or level unsupported by the decoder are shown. In many embodiments, the decoder determines whether a compressed video bit stream can be played back by parsing the elementary stream and looking for information concerning the encoding that indicates that the bit stream can be played back by the decoder. In several embodiments, the decoder is configured to playback H.264 High Profile Level 4.0 or a subset thereof and inspects all H.264 High Profile Level 4.0 and Level 4.1 streams that include a User Data Unregistered Supplemental Enhancement (SEI) message (User Data Unregistered SEI message syntax specified in D.1.6 of ITU-R recommendation H.264) by parsing the message to extract the UUID and ASCII user data and plays back the stream when the following four conditions are satisfied:
1. User Data Unregistered SEI message starts with a 16 byte UUID
2. ASCII user data starts with ‘x264’, or alternatively if the UUID is equal to 0xdc, 0x45, 0xe9, 0xbd, 0xe6, 0xd9, 0x48, 0xb7, 0x96, 0x2c, 0xd8, 0x20, 0xd9, 0x23, 0xee, 0xef
3. ASCII user data indicates the following parameter specifications:
   a. rc=2pass, or rc=abr
   b. qpmax=51
4. ASCII user data indicates at least one of the following two conditions with respect to ‘bitrate’, ‘vbv_maxrate’, and ‘vbv_bufsize’:
   a. bitrate=<10,000
   b. bitrate=<20,000, vbv_maxrate=<20,000, and vbv_bufsize=<25,000

The above conditions examine certain facets of the encoding process captured in the User Data field, namely the rate-control mode, the maximum quantizer value, the average target bit-rate, the maximum HRD bit-rate, and the maximum CPB buffer size. A customized profile may be defined as a maximum bit-rate of 20 Mbits/s and a maximum CPB buffer size of 25 Mbits/s, in which case the maximum average bit-rate must also be limited to 20 Mbits/s. Alternatively, a stream may be inspected to have an average bit-rate that is less than 10 Mbits/s, in which case it may be assumed that the maximum bit-rate and the maximum CPB buffer size are also compatible with a custom-specified profile. For the above conditions to be correct, the stream may have to be encoded according to a 2-pass encoding algorithm or an average bit-rate (abr) encoding algorithm. In addition, the maximum quantizer value (qpmax) is likely to be equal to 51. An important consideration is that some of the ASCII parameters representing the specific fields of interest may be changed in the future; in such an event, the new representations of these same parameters may be utilized directly and/or derived indirectly in verifying the above four conditions.

### Distribution of Video Content Accessible Via the Internet

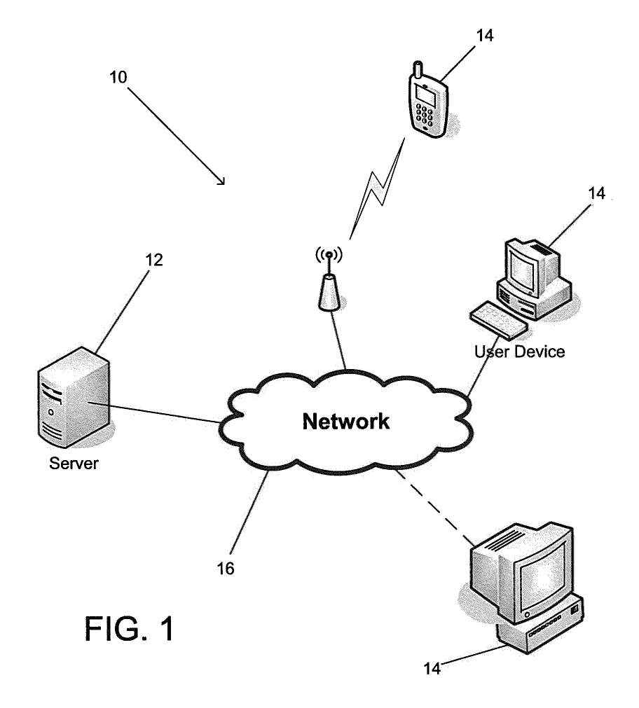

Video content available via the Internet can be accessed by decode devices in a variety of different ways including downloading or streaming the file directly via the Internet, streaming of downloaded files via a local area network, or indirectly via fixed media on which the video content is stored following download via Internet. A number of decode devices configured to playback video content compressed in accordance with a standard is illustrated in FIG. 1. In the illustrated system 10, the video content is typically stored on a server 12 or on a peer system. A variety of decode devices 14 can request the video content and download the video content via a network 16. In the illustrated embodiment, the decode devices include a mobile phone, a personal computer, and a consumer electronics device such as a Blu-Ray player, HD television, or a set top box (which may or may not be connected to the Internet). Many other decode devices can be utilized that determine bit stream compatibility in accordance with embodiments of the invention. Video content can be downloaded via a network for playback via a network connected playback device. In addition, once downloaded the files can be transferred from one device to another via a fixed media such as a CD, DVD, or a solid-state memory drive such as a flash drive. Alternatively, the video content can also be streamed over the network. Accordingly, decoders in accordance with embodiments of the invention are not in any way limited in terms of the manner in which the decode devices are configured to receive a video stream encoded in accordance with the standard.

### Playback of Video Content

When a video stream is received by a decoder in accordance with an embodiment of the invention, the decoder inspects the video stream to determine whether it is capable of playback based upon the profile and/or level with which the video stream was encoded. In the event that the video stream is encoded with a profile and/or level that exceed the capabilities of the decoder, then the decoder can inspect the video stream to determine whether the decoder is likely capable of playing back the video stream despite the profile and/or level labeling of the video stream indicating playback is unsupported.

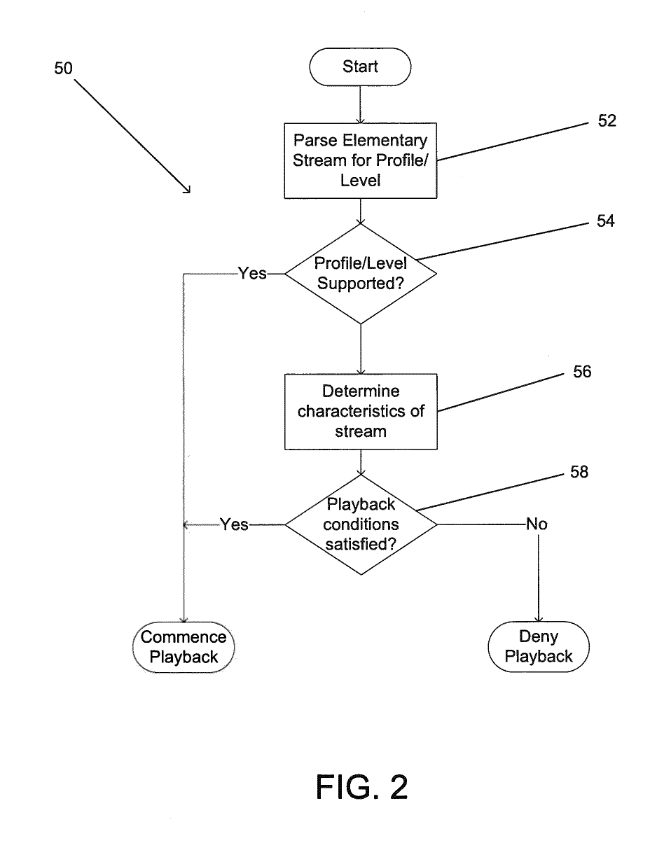

A process for determining whether a decoder can playback a video stream in accordance with an embodiment of the invention is illustrated in FIG. 2. The process 50 commences with the parsing (52) of the elementary stream for the profile and/or level of the bit stream. A determination is made (54) concerning whether playback of a bit stream encoded in accordance with the profile and/or level is supported. In the event that playback of a bit stream encoded in accordance with the profile and/or level is supported, then playback commences. Otherwise, the characteristics of the bit stream are determined (56) and a decision (58) made as to whether predetermined playback conditions are satisfied. In case a decoder is capable of playing back only a subset of a standard profile and/or level, further characteristics of the stream are inspected to determine playability. The playback conditions are typically characteristics of the bit stream that are indicative of the ability to decode the bit stream despite the bit stream being encoded with a profile and/or level that is not supported. Various examples of predetermined playback conditions for different bit streams are discussed below. In the event that the playback conditions are satisfied, playback commences. In the event that the playback conditions are not satisfied, then playback is denied. Although a specific process is illustrated in FIG. 2, other processes that involve verifying whether the bit stream can be played back despite a lack of support for the profile and/or level with which the bit stream was encoded can be implemented in accordance with embodiments of the invention.

### Overview of H.264 Content Accessible Via the Internet

A significant amount of video compressed in accordance with the H.264 standard is available via the Internet. A significant proportion of the H.264 video available via the Internet is labeled High Profile Level 4.1, which is the level more typically associated with fixed media such as Blu-Ray discs. Many H.264 decoders designed to decode video downloaded from the Internet are only capable of decoding video encoded in accordance with H.264 High Profile Level 4.0 and/or a subset thereof, which is the profile better suited for video distribution via the Internet. Analysis of much of the H.264 content labeled High Profile Level 4.1 available via the Internet has revealed that the content is capable of playback on a decoder that only implements High Profile Level 4.0 and/or a subset thereof. In order for the content labeled High Profile Level 4.1 to be sufficiently compressed for distribution via the Internet, the resulting bit stream's operating characteristics typically fall within bounds that enable playback on a device constrained to playing back content with operating parameters defined in High Profile Level 4.0 and/or a subset thereof. Therefore, decoders in accordance with embodiments of the invention, which are capable of playing back H.264 High Profile Level 4.0 bit streams and/or a subset thereof, are configured to analyze H.264 High Profile Level 4.1 bit streams to ascertain whether the characteristics of the bit stream fall within bounds enabling playback on the decoder.

### Identifying Characteristics of H.264 Level 4.1 Streams

In many instances, an encoder used to encode a video stream in accordance with a standard labels the video stream in accordance with a specific operating profile and separately includes information concerning the characteristics of the video stream. For example, a large proportion of videos encoded in accordance with the H.264 standard are encoded using tools based upon the X264 open source library for encoding H.264 video streams (http://www.videolan.org/developers/x264.html). Bit streams encoded using the X264 libraries include a User Data Unregistered SEI message in bit streams that contains a 16 byte UUID with the values 0xdc, 0x45, 0xe9, 0xbd, 0xe6, 0xd9, 0x48, 0xb7, 0x96, 0x2c, 0xd8, 0x20, 0xd9, 0x23, 0xee, 0xef, and a block of user data in ASCII format. The first four characters of the user data are typically “x264”, and the user data typically includes fields that describe the characteristics of the video stream including the maximum quantization parameter (i.e. “qpmax”), the rate-control mode (i.e. “rc”), the average bit rate (i.e. “bitrate”), the HRD maximum bit rate (i.e. “vbv_maxrate”), and the CPB maximum buffer size (i.e. “vbv_bufsize”). An example of a block of user data generated by an encoder based upon the X264 libraries is as follows:
x264, core 67 r1145 d2e1e1c, H.264/MPEG-4 AVC codec, Copyleft 2003-2009, http://www.videolan.org/x264.html, cabac=1, ref=5, deblock=1:0:0, analyse=0x3:0x113, me=umh, subme=7, psy_rd=1.0:0.0, mixed_ref=1, me_range=16, chroma_me=1, trellis=1, 8x8dct=1, cqm=0, deadzone=21,11, chroma_qp_offset=−2, threads=6, nr=0, decimate=1, mbaff=0, bframes=3, b_pyramid=1, b_adapt=1, b_bias=0, direct=1, wpredb=1, keyint=250, keyint_min=25, scenecut=40, rc=2pass, bitrate=4768, ratetol=1.0, qcomp=0.60, qpmin=10, qpmax=51, qpstep=4, cplxblur=20.0, qblur=0.5, ip_ratio=1.40, pb_ratio=1.30, aq=1:1.00,

A decoder in accordance with an embodiment of the invention can parse a video stream encoded in accordance with a specific standard for profile and/or level information. In the event, that the video stream is labeled with a profile and/or level that the decoder does not support or only supports partially, then the decoder can inspect the video stream for information inserted into the video stream concerning the stream's characteristics. Based upon the characteristics of the stream, the decoder can make a separate determination concerning whether the decoder is capable of playing back the stream. In the case of a H.264 High Profile Level 4.1 video stream, a decoder in accordance with embodiments of the invention that is limited to playing back H.264 High Profile Level 4.0 video streams and/or a specific subset thereof can look for inserted information in the Level 4.1 video stream such as, but not limited to, a User Data Unregistred SEI message. The decoder can use the information concerning the characteristics of the video stream to determine whether to play back the video stream.

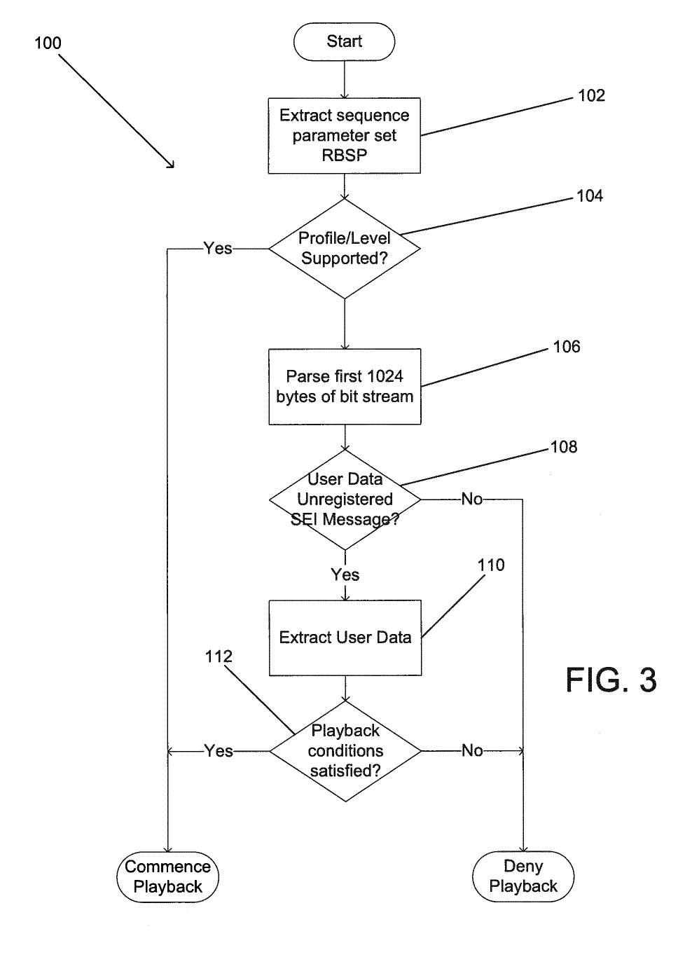

A process for determining whether to playback a video stream using a H.264 High Profile Level 4.0 decoder in accordance with an embodiment of the invention is illustrated in FIG. 3. The process 100 commences with the extraction (102) of the sequence parameter set RBSP from the elementary bit stream. A determination is made (104) concerning whether the profile and level of the elementary bit stream is supported. In the event the profile and level of the bit stream are supported, then playback commences. Otherwise, the first 1024 bytes of the bit stream are parsed (106) to locate (108) a User Data Unregistered SEI message or another message containing information concerning the bit stream. In the event that a User Data Unregistered SEI message is not located, then the process denies playback. Otherwise, the user data is extracted (110) from the User Data Unregistered SEI message and a determination is made (112) concern whether predetermined playback conditions are met. As discussed above, the playback conditions are typically indicative of an ability to decode the bit stream despite a lack of support for the decoding of bit streams encoded with the profile and level used to encode the bit stream. In the event the predetermined playback conditions are satisfied, playback commences. Otherwise, the process denies playback. Although the process shown in FIG. 3 involves utilizing information embedded in messages within the elementary stream by the encoder, many embodiments rely upon other information including but not limited to information determined by studying the bit stream.

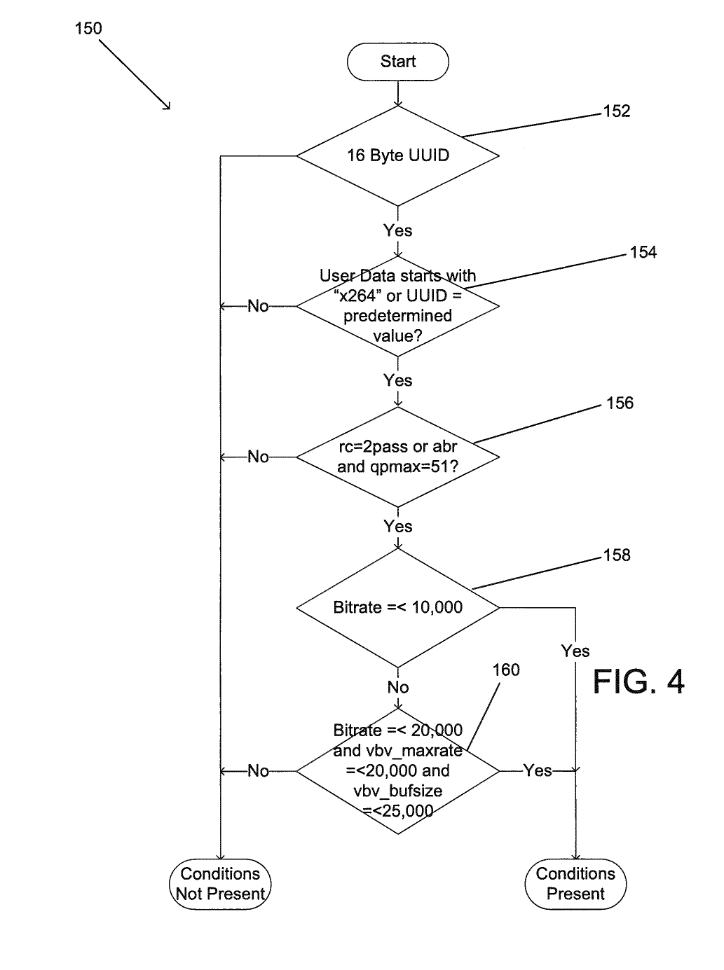

A process for determining whether an elementary bit stream was created using the X264 open source library and whether the bit stream is capable of being played back on a decoder supporting a subset of the High Profile Level 4.0 using user data retrieved from a User Data Unregistered SEI message in accordance with an embodiment of the invention is illustrated in FIG. 4. The process 150 includes determining three initial conditions:
1) a determination is made (152) as to whether the UUID of the User Data Unregistered SEI message is 16 bytes;
2) and a determination is made (154) as to whether:
   a. The user data starts with “x264”; or alternatively
   b. The UUID equals 0xdc, 0x45, 0xe9, 0xbd, 0xe6, 0xd9, 0x48, 0xb7, 0x96, 0x2c, 0xd8, 0x20, 0xd9, 0x23, 0xee, 0xef
3) a determination (156) is made concerning whether rc=2pass or rc=abr and whether qpmax=51.

If any of the above conditions are not met, then the playback conditions are not met. In the event that all three conditions are met, a determination is made (158) concerning whether bitrate=<10,000. When bitrate=<10,000, then the playback conditions are satisfied. In the event bitrate exceeds 10,000, then a determination is made (160) as to whether bitrate=<20,000, vbv_maxrate=<20,000 and vbv_bufsize=<25,000. In the event these conditions are present, then the playback conditions are satisfied. Otherwise, the playback conditions are not present. Although specific thresholds and conditions are specified above, alternative thresholds and conditions can be used to determine whether playback conditions are met based upon the capabilities of a specific decoder and/or user data known to be embedded by different encoders in accordance with embodiments of the invention.

Although the present invention has been described in certain specific aspects, many additional modifications and variations would be apparent to those skilled in the art. It is therefore to be understood that the present invention may be practiced otherwise than specifically described, including various changes in the implementation such as utilizing encoders and decoders that support features beyond those specified within a particular standard with which they comply, without departing from the scope and spirit of the present invention. Thus, embodiments of the present invention should be considered in all respects as illustrative and not restrictive.

What is claimed is:

1. A system for playing back video encoded as an elementary bitstream, where the elementary bitstream has a specified encoding profile and satisfies at least one playback condition, the system comprising:
a decoder that is incapable of playing back video encoded in accordance with the specified encoding profile;
wherein the decoder is configured to locate the specified encoding profile within the elementary bitstream;
wherein the decoder is configured to determine whether the elementary bitstream satisfies the at least one playback condition in response to the location of the specified encoding profile within the elementary bitstream; and
wherein the decoder is configured to commence playback of the elementary bitstream based upon the determination that the at least one playback condition is satisfied.

2. The system of claim 1, wherein the specified encoding profile includes at least a bit stream profile.

3. The system of claim 2, wherein the specified encoding profile further comprises a bit stream level.

4. The system of claim 3, wherein the specified encoding profile includes a bitstream profile and a bitstream level in the sequence parameter set in a raw byte sequence payload within an H.264 bitstream.

5. The system of claim 1, wherein the specified encoding profile comprises:
at least one identifier specifying an encoder;
a value specifying a rate-control mode; and
a value specifying a maximum value for a quantizer parameter.

6. The system of claim 5, wherein the at least one identifier is a Universally Unique Identifier (UUID).

7. The system of claim 6, wherein the at least one identifier also includes user data.

8. The system of claim 7, wherein the at least one playback condition is satisfied where:
the UUID is 16 bytes;
the user data starts with x264; and
the rate-control mode is 2pass and the maximum value for a quantizer parameter is 51.

9. The system of claim 7, wherein the at least one playback condition is satisfied where:
the UUID is 16 bytes;
the user data starts with x264; and
the rate-control mode is adjustable bit rate and the maximum value for a quantizer parameter is 51.

10. The system of claim 6, wherein the at least one playback condition is satisfied where:
the UUID is 16 bytes;
the UUID is 0xdc, 0x45, 0xe9, 0xbd, 0xe6, 0xd9, 0x48, 0xb7, 0x96, 0x2c, 0xd8, 0x20, 0xd9, 0x23, 0xee, 0xef; and
the rate-control mode is 2pass and the maximum value for a quantizer parameter is 51.

11. The system of claim 6, wherein the at least one playback condition is satisfied where:
the UUID is 16 bytes;
the UUID is 0xdc, 0x45, 0xe9, 0xbd, 0xe6, 0xd9, 0x48, 0xb7, 0x96, 0x2c, 0xd8, 0x20, 0xd9, 0x23, 0xee, 0xef; and
the rate-control mode is adjustable bit rate and the maximum value for a quantizer parameter is 51.

12. The system of claim 5, wherein the at least one identifier is a User Data Unregistered SEI message.

13. The system of claim 12, wherein the at least one identifier also includes user data.

14. The system of claim 13, wherein the at least one playback condition is satisfied where:
the User Data Unregistered SEI message is 16 bytes;
the user data starts with x264; and
the rate-control mode is 2pass and the maximum value for a quantizer parameter is 51.

15. The system of claim 13, wherein the at least one playback condition is satisfied where:
the User Data Unregistered SEI message is 16 bytes;
the user data starts with x264; and
the rate-control mode is adjustable bit rate and the maximum value for a quantizer parameter is 51.

16. The system of claim 12, wherein the at least one identifier also includes a Universally Unique Identifier (UUID).

17. The system of claim 16, wherein the at least one playback condition is satisfied where:
the User Data Unregistered SEI message is 16 bytes;
the UUID is 0xdc, 0x45, 0xe9, 0xbd, 0xe6, 0xd9, 0x48, 0xb7, 0x96, 0x2c, 0xd8, 0x20, 0xd9, 0x23, 0xee, 0xef; and
the rate-control mode is 2pass and the maximum value for a quantizer parameter is 51.

18. The system of claim 16, wherein the at least one playback condition is satisfied where:
the User Data Unregistered SEI message is 16 bytes;
the UUID is 0xdc, 0x45, 0xe9, 0xbd, 0xe6, 0xd9, 0x48, 0xb7, 0x96, 0x2c, 0xd8, 0x20, 0xd9, 0x23, 0xee, 0xef; and
the rate-control mode is adjustable bit rate and the maximum value for a quantizer parameter is 51.

19. The system of claim 1, wherein the at least one playback condition is a characteristic of the elementary bitstream that is indicative of the ability of the decoder to play back the bit stream.

20. The system of claim 19, wherein the data to evaluate the playback condition is in user data.

21. The system of claim 20, wherein the user data is in the User Data Unregistered SEI message in the first 1024 bytes of the bitstream.

22. The system of claim 20, wherein the user data is in a message concerning the bitstream.

23. The system of claim 19, wherein the at least one playback condition is an average bit rate.

24. The system of claim 23, wherein the at least one playback condition is satisfied where the average bit rate is less than or equal to 10,000.

25. The system of claim 19, wherein the at least one playback condition is satisfied where:
the average bit rate is less than or equal to 20,000;
Hypothetical Reference Decoder (HRD) maximum bit rate is less than or equal to 20,000; and
Coded Picture Buffer (CPB) maximum buffer size is less than or equal to 25,000.

26. A method of playing back video encoded as an elementary bitstream using a decoder, where the decoder is incapable of playing back video encoded in accordance with at least one encoding profile, the method comprising:
parsing the elementary bit stream to locate a specified encoding profile;
evaluating whether the decoder is capable of playing back video encoded in accordance with the specified encoding profile;
parsing the elementary bit stream to evaluate at least one playback condition when the decoder is incapable of playing back video encoded with the stated encoding profile; and
commencing playback of the elementary bitstream when the elementary bit stream satisfies the at least one playback condition.
